(19) United States
(12) Patent Application Publication
(10) Pub. No.: US 2026/0362285 A1
(43) Pub. Date: Nov. 12, 2026

(54) Alternate Communication Path

(71) Applicant: Comcast Cable Communications, LLC, Philadelphia, PA (US)

(72) Inventors: Thomas Michael McClung, Lacey, NJ (US); Gustavo Saracho, Frederick, CO (US); Gerald A. Mason, JR., Frederick, CO (US)

(21) Appl. No.: 19/204,224

(22) Filed: May 9, 2025

(51) Int. Cl. H04W 40/12; H04L 65/1104; H04W 56/00

(52) U.S. Cl. CPC H04W 40/12; H04L 65/1104; H04W 56/0015

(57) ABSTRACT

Systems, apparatuses, and methods are described for providing an active-alternate path for a priority call. A controller may host a call session between two devices, in which information associated with an alternate path for the call may be inserted into a packet and stored. The two devices may communicate with each other using the controller as the host of the call. The controller may transfer the call session to an alternate controller without disconnecting the call between the two devices. Transferring the call may be based on occurrence of a call condition.

### BACKGROUND

A call between a device (e.g., a mobile phone) and an end-point may be disconnected for a variety of reasons, such as an unforeseen natural disaster occurring at a location (e.g., a data center) that is hosting a call session corresponding to the call. If the call is related to an emergency event (or other priority event), then the disconnection may lead to worsening of the event.

### SUMMARY

The following summary presents a simplified summary of certain features. The summary is not an extensive overview and is not intended to identify key or critical elements.

Systems, apparatuses, and methods are described for providing an alternate path for a priority call. An initiating device may request to initiate a priority call with an end-point device (e.g., a receiving device). A controller may establish and/or host a communication session (e.g., a call session) between the initiating device and the end-point device corresponding to the priority call. The initiating device may receive information from the controller that indicates an active-alternate path (e.g., an alternate path that may be used to maintain the call using the alternate path and without disconnecting the call, based on the request indicating the priority call) for the call if the controller is not able to maintain a call session corresponding to the call (due to, for example, a call condition, e.g., poor quality with respect to the call, or a call failure). If a determination is made that the quality associated with the call is low, due to, for example, a quantity of packet loss that exceeds a threshold, then the call may be automatically transferred to and maintained using the alternate path information that was previously received. For example, the controller may insert the packet header information into a message (e.g., a SIP message) that indicates the alternate path, which is sent to the initiating device. An advantage with this setup is that the priority call may be maintained using the alternate path (e.g., the priority call may remain active), rather than having to be re-established, as disconnecting and reconnecting a priority call may lead to issues with respect to the event that gave rise to the priority call.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A-3B are example block diagrams of a system for establishing a call and maintaining the call using an active-alternate path.

FIGS. 4A-4D show an example sequence for establishing a call and maintaining the call using an active-alternate path.

FIGS. 5A-5C show examples of information that may be used to maintain a call using an active-alternate path.

FIG. 6 is a flow chart showing an example method for establishing and maintaining a call using an active-alternate path .

FIG. 7 is a flow chart showing an example method for establishing and maintaining a call using an active-alternate path .

FIG. 8 is a flow chart showing an example method for establishing and maintaining a call using an active-alternate path.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

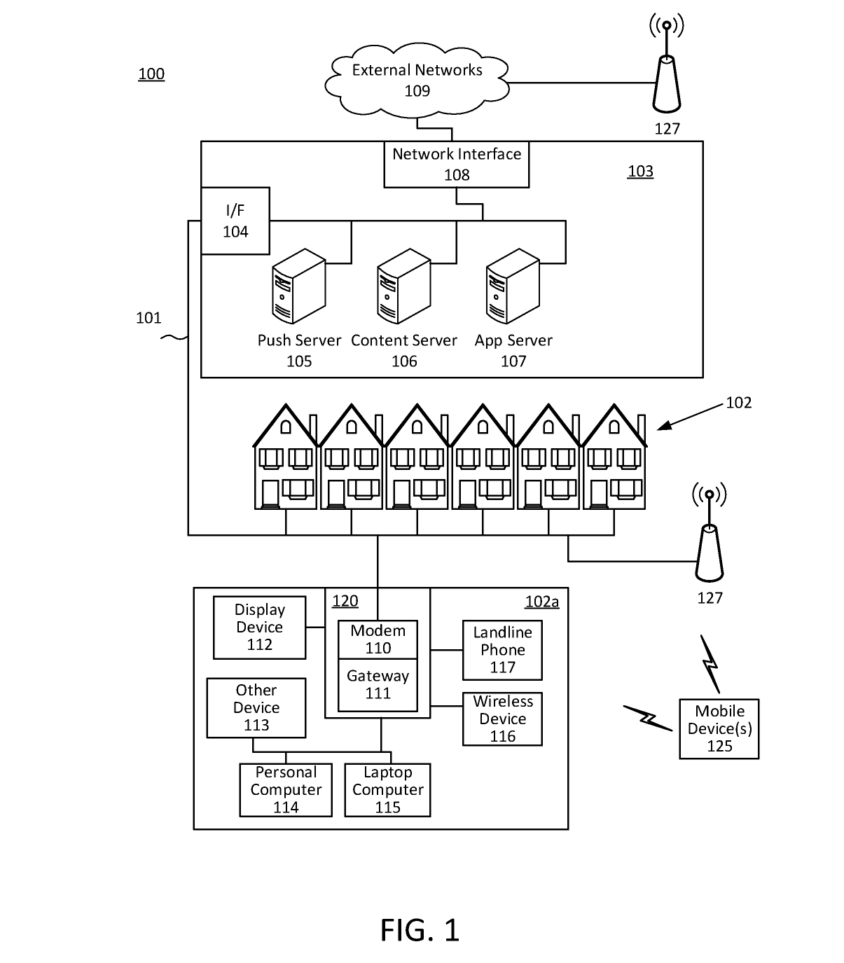

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

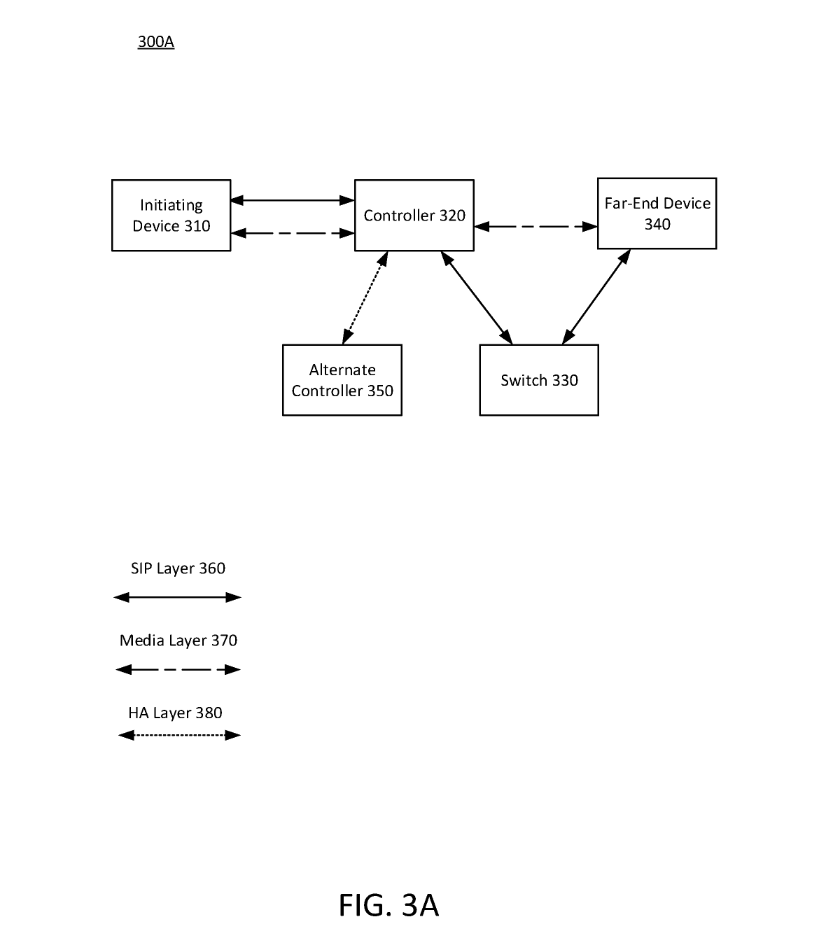

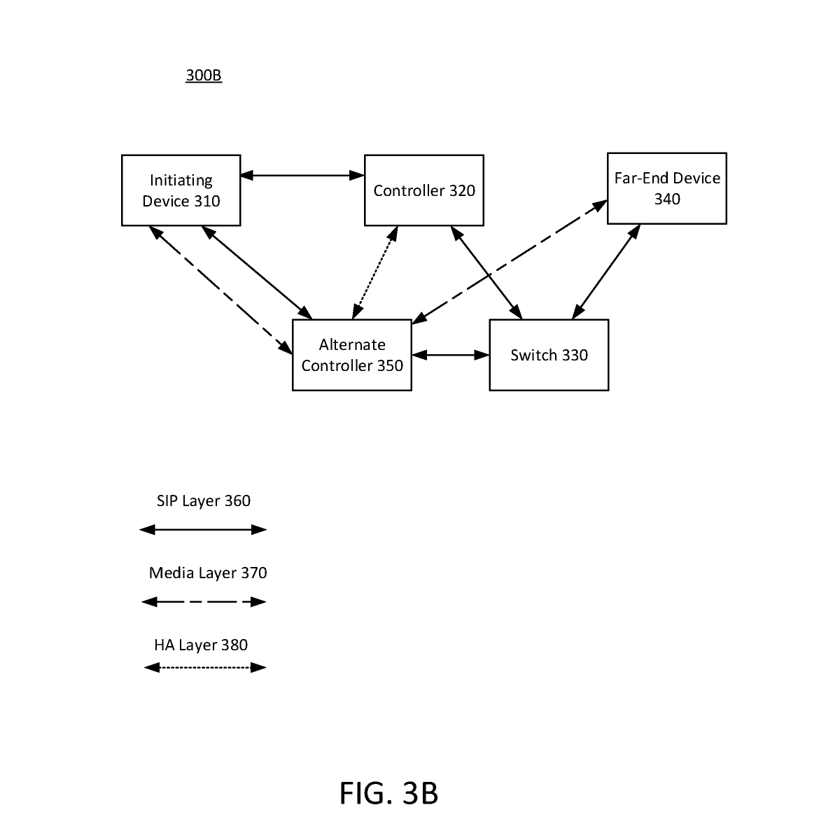

For example, a mobile device 125 could make a request to establish a call, in which the request may indicate the call is a priority call (e.g., associated with an emergency event), as discussed in more detail with respect to FIGS. 3A, 4A, and 8.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

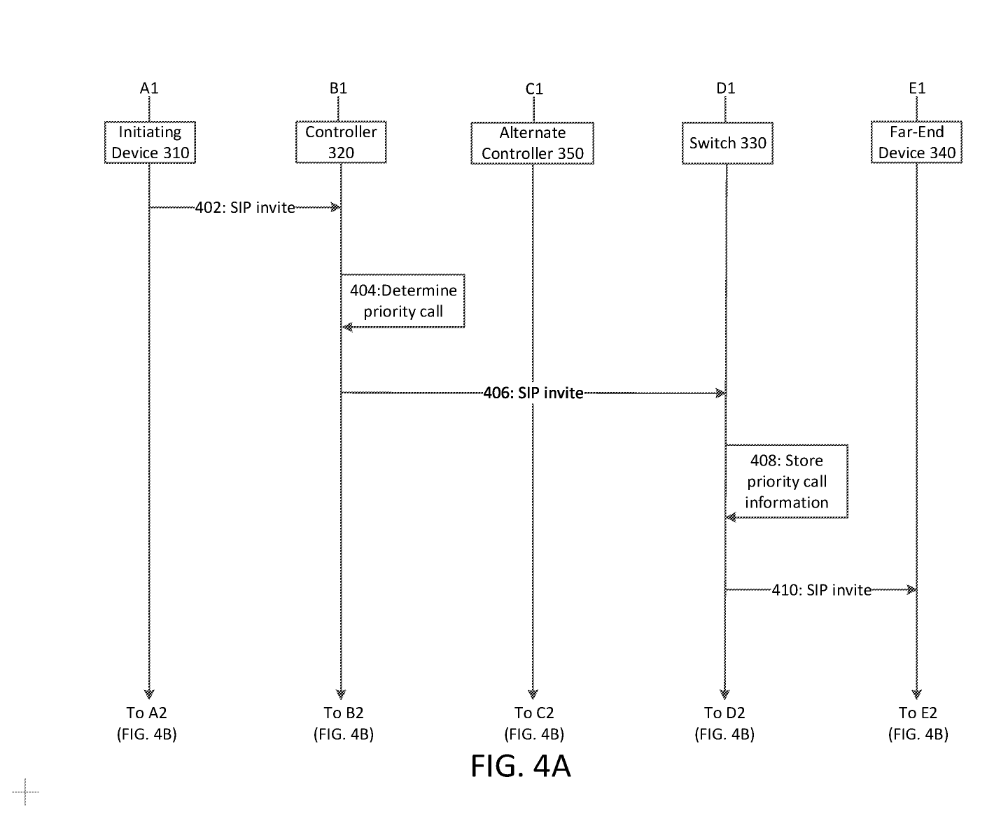

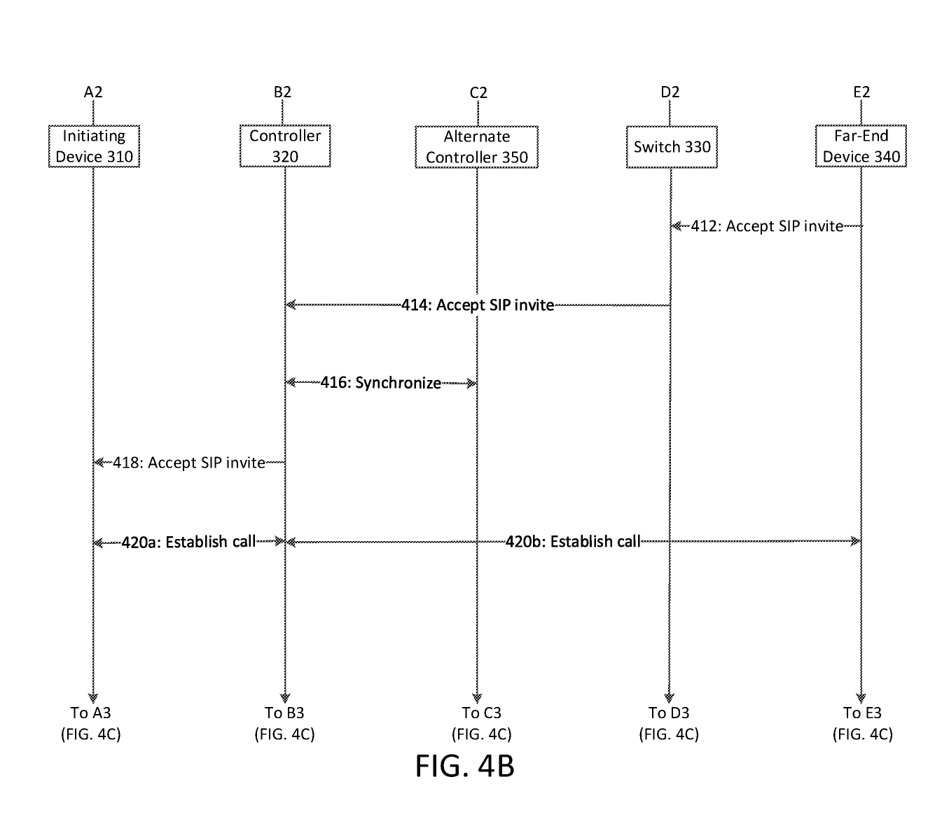

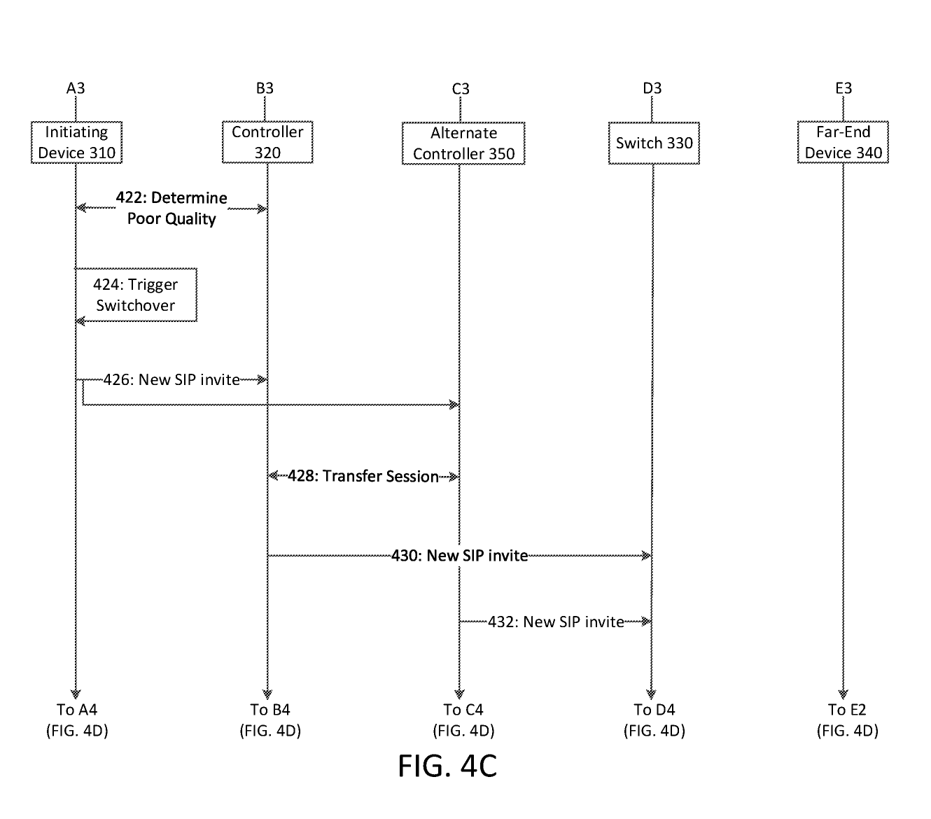

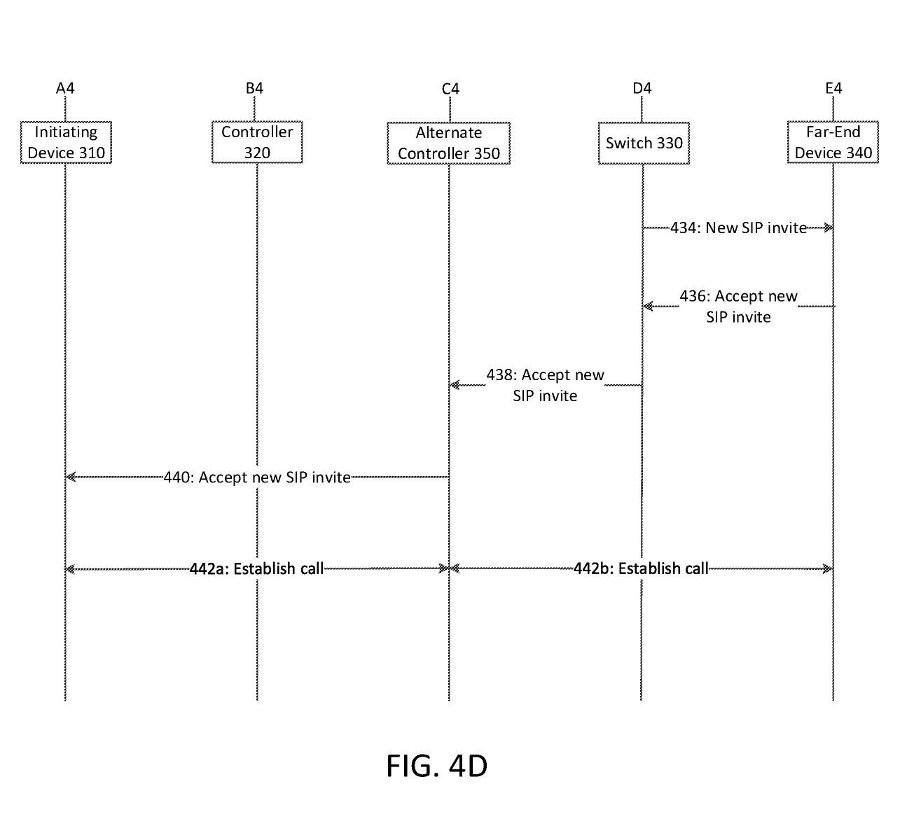

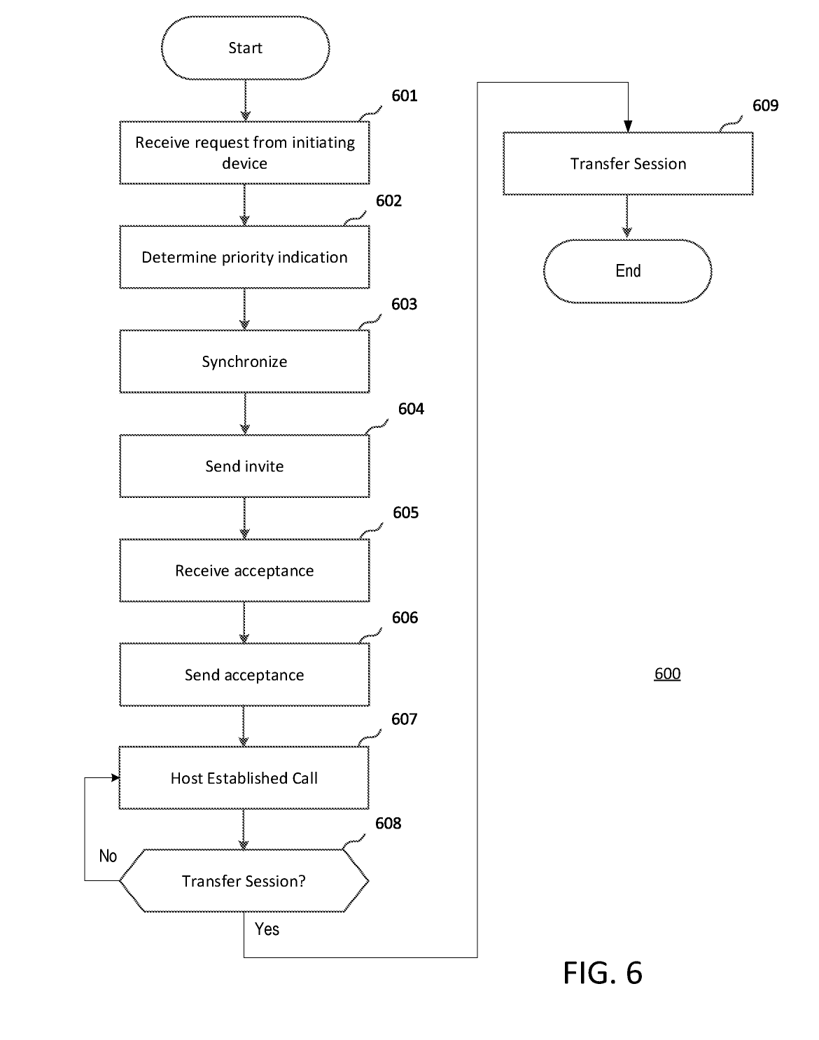

For example, the external networks 109 may be used to establish, maintain and/or transfer a priority call using an alternate path, as discussed in more detail with respect to FIGS. 3A,B, FIGS. 4A,B, and FIGS. 6-8. For example, a controller (e.g., controller 320 of FIGS. 3A,B) for hosting a call session, a switch (e.g., switch 330 of FIGS. 3A,B) for routing a request to establish a call, and an alternate controller (e.g., alternate controller 350 of FIGS. 3A,B) for hosting a transferred call session, may be connected to the external networks 109, and perform the functions described herein.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, additional push, content, and/or application servers, and/or other types of servers. Although shown separately, the push server 105, the content server 106, the application server 107, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

For example, the landline phone 117 or the mobile devices 125 could make a request to establish a call, in which the request may indicate the call is a priority call, or associated with an emergency event, as discussed in more detail with respect to FIGS. 3A, 4A and 8. The mobile devices 125, one or more of the devices in the premises 102a, and/or other devices may receive, store, output, and/or otherwise use assets. An asset may comprise a video, a game, one or more images, software, audio, text, webpage(s), and/or other content.

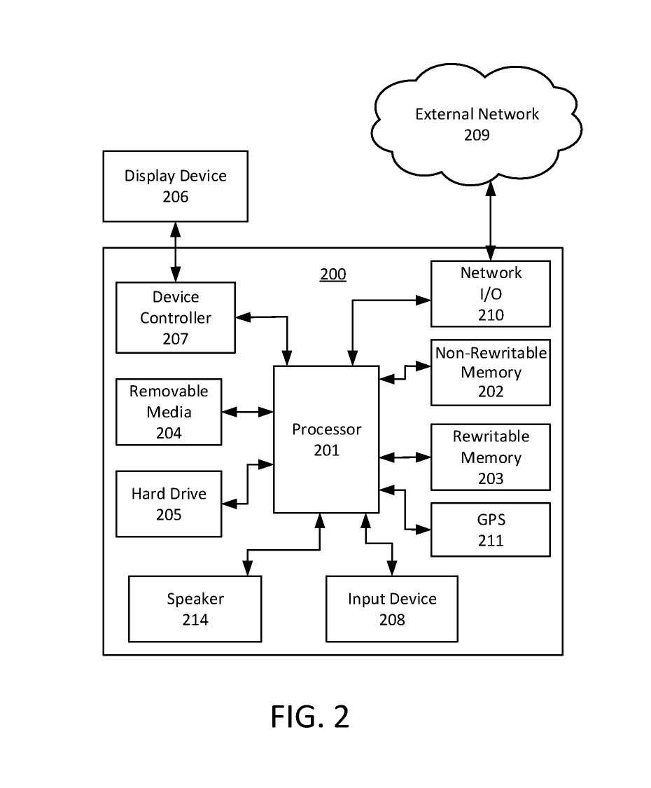

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., the initiating device 310, controller 320, switch 330, far-end device 340, and/or alternate controller 350). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider’s wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIGS. 3A-3B show a block diagram of a system for establishing a call and maintaining the call using an active-alternate path. Any of the devices described by either of FIGS. 3A or 3B may be connected to the external networks 109 (FIG. 1). Referring to FIG. 3A, system 300A includes an initiating device 310 (e.g., the mobile device 125 of FIG. 1), a controller 320, a switch 330, a far-end device 340, an alternate controller 350, a SIP layer 360, a media layer 370, and an HA layer 380.

The initiating device 310 may correspond to an individual in, for example, a priority (e.g., emergency) event that may require specialized assistance. Because of the potential serious nature of the event, the initiating device 310 may need to establish and maintain the call without the call being disconnected (e.g., remain active), even for a short period of time to re-establish the call, in which case the event may get worse if the call is disconnected. The initiating device 310 may send a request to the controller 320 to establish a call session with the far-end device 340, and the request may contain information that indicates the call may be associated with priority event, as discussed in more detail with respect to FIG. 4A.

The controller 320 may be a network device, such as a session initiation protocol (SIP) network device, that may correspond to, a data center in a geographic location near the initiating device 310. For example, the controller 320 may be a session border controller (SBC). The controller 320 may establish and/or host a call session for the initiating device 310, based on receiving a request to establish a call. For example, based on receiving the request from the initiating device 310 and determining that the request includes an indication of a priority call, the controller 320 may identify and/or establish an alternate path for the call so that the call session may be transferred to the alternate path without the call being disconnected.

The switch 330 may comprise a computing device and/or a server. The switch 330 may comprise a softswitch (e.g., software based) and/or a hardware-based switch. In one or more example configurations, the switch 330 may comprise one or more software-based applications, for example, executing on a server, a hardware system, and/or virtualized functions configured to perform the operations of the switch 330 described herein. The switch 330 may route a request to establish a call from the controller 320 to an end-point of the call, such as the far-end device 340. In some cases, the switch 330 may be co-located with the controller 320 (e.g., within the same call center). For example, the switch 330 may support the establishing of a call session between the initiating device 310 and the far-end device 340 using the controller 320 as the host of the call session by routing a request (e.g., a SIP invite) to establish the call session from the controller 320 to the far-end device 340, as discussed in more detail with respect to FIG. 4A.

The far-end device 340 (e.g., a receiving device) may be, for example, a public safety answering point (PSAP), which may represent an emergency operator that answers priority calls. In some cases, the far-end device 340 may be another controller similar to the controller 320 without departing from the scope of the disclosure.

The alternate controller 350 may be a network device, such as a SIP network device, that may be an alternate session host for the controller 320 hosting the call, in the event of a call condition, for example, poor quality between the initiating device 310 and the controller 320, or a call failure (e.g., occurrence of a disconnection between the initiating device 310 and the controller 320). For example, information stored at the controller 320 may designate the alternate controller 350 as a backup device to host the call associated with the initiating device 310 and the far-end device 340. For example, the alternate controller 350 may be designated as alternative to the controller 320 based on the alternate controller 350 being located in a data center in a different geographic region/proximity from the controller 320. For example, the controller 320 may be preconfigured to store an indication that the alternate controller 350 is designated as alternative to the controller 320.

The SIP layer 360 is a SIP layer that is a signaling layer in which packets may be sent and received in order to establish a call and/or transfer a call to an alternate path. The media layer 370 is a media layer (e.g., voice for a phone call) in which the call takes place between the initiating device 310 and the far-end device 340. HA layer 380 is a high-availability layer (via, e.g., a high-availability interface) that is used by controllers (e.g., the controller 320 and alternate controller 350) to synchronize and communicate with each other, in furtherance of coordinating and transferring a call from a current path to an alternate path.

As shown by FIG. 3A, the initiating device 310 can communicate with the controller 320, for example, via the SIP layer 360 to send a SIP invite that contains a request to establish a call with the far-end device 340. The SIP invite may also include information that contains a priority indication. The controller 320 may note the priority indication, and determine that the alternate controller 350 may serve as an alternate device to host the call session, for example, if the call is transferred due to the current call path (e.g., the media layer 370) having poor quality associated with the call, or in the event a call failure occurs during the call session (e.g., occurrence of a call condition). The controller 320 may also communicate with the switch 330 via the SIP layer 360, to route a SIP invite from the initiating device 310 to the far-end device 340, in furtherance of establishing a call session between the initiating device 310 and the far-end device 340. The switch 330 may similarly communicate with the far-end device 340 via the SIP layer 360 to route a SIP invite from the controller 320 to the far-end device 340. The controller 320 may communicate with the alternate controller 350 using the HA layer 380. Once the call has been established, the initiating device 310 and the far-end device 340 may communicate with each other via the media layer 370, using the controller 320 as the host for the call session. Although the connections/layers are shown in a particular configuration with respect to FIG. 3A, additional or fewer connections/layers may be made without departing from the scope of the disclosure.

Referring to FIG. 3B, system 300B includes an initiating device 310, a controller 320, a switch 330, a far-end device 340, an alternate controller 350, a SIP layer 360, a media layer 370, and an HA layer 380. The devices described with reference to FIG. 3A may be the same as the devices described with reference to FIG. 3B (e.g., the initiating device 310, the controller, the switch 330, the far-end device 340, and/or the alternate controller 350). However, as discussed below, the communication paths (e.g., signaling and/or media paths) between the devices may be different, because FIG. 3B refers to the situation in which the call is transferred to the alternate path. For example, in comparison to FIG. 3A, in which the controller 320 hosts the call session between the initiating device 310 and the far-end device 340, in FIG. 3B, the alternate controller 350 hosts the call session between the initiating device 310 and the far-end device 340 after the call is transferred.

The initiating device 310 may communicate with the controller 320 via the SIP layer 360 to send a new SIP invite that contains a request to transfer a call with the far-end device 340 that is currently being hosted by the controller 320, to the alternate controller 350. The initiating device 310 may send the request after determining there is poor quality associated with the call, which may indicate that there may be an issue with respect to the operation of the controller 320, or the data center in which the controller 320 is located. Alternatively, the initiating device 310 may send the request after occurrence of a call failure associated with the call session. The controller 320 may also communicate with the switch 330 via the SIP layer 360, for example, to route a new SIP invite from the initiating device 310 to the far-end device 340, in furtherance of transferring the call session using an alternate path so that the alternate controller 350 may host the call session instead of the controller 320. The switch 330 may communicate with the far-end device 340 via the SIP layer 360 to route the new SIP invite from the controller 320 to the far-end device 340. The controller 320 may communicate with the alternate controller 350 using the HA layer 380, for example, in order to transfer the call session. The initiating device 310 and the alternate controller 350 may communicate via the SIP layer 360 in furtherance of transferring the call and/or establishing an updated call session. The initiating device 310 and the far-end device 340 may communicate with each other using the media layer 370 and with the alternate controller 350 hosting the call session, for example, in the event the call session is transferred from the controller 320 to the alternate controller 350. Although the connections/layers are shown in a particular configuration with respect to FIG. 3B, additional or fewer connections/layers may be made without departing from the scope of the disclosure.

FIGS. 4A-4D show an example sequence for establishing a call and maintaining the call using an active-alternate path. Vertical lines A1 (FIG. 4A), A2 (FIG. 4B), A3 (FIG. 4C), and A4 (FIG. 4D), correspond to the initiating device 310. Vertical lines B1 (FIG. 4A), B2 (FIG. 4B), B3 (FIG. 4C), and B4 (FIG. 4D) correspond to the controller 320. Vertical lines C1 (FIG. 4A), C2 (FIG. 4B), C3 (FIG. 4C), and C4 (FIG. 4D), correspond to the alternate controller 350. Vertical lines D1 (FIG. 4A), D2 (FIG. 4B), D3 (FIG. 4C), and D4 (FIG. 4D) correspond to the switch 330. Vertical lines E1 (FIG. 4A), E2 (FIG. 4B), E3 (FIG. 4C), and E4 (FIG. 4D), correspond to the far-end device 340. FIG. 4B is a continuation of FIG. 4A, as indicated at the bottom of FIG. 4A and at the top of FIG. 4B. FIG. 4C is a continuation of FIG. 4B, as indicated at the bottom of FIG. 4B and at the top of FIG. 4C. FIG. 4D is a continuation of FIG. 4C, as indicated at the bottom of FIG. 4C and at the top of FIG. 4D. Although FIGS. 4A-4D show certain computing devices from FIG. 1 as examples of computing devices that may perform one or more of the steps described below, one, some, or all of those steps may be performed by one or more other computing devices. The devices shown in FIGS. 4A-4D (and/or other computing devices) may be configured (e.g., based on stored instructions) to perform steps such as are described herein. One or more of the communications and/or steps shown in FIGS. 4A-4D may be rearranged, omitted, and/or otherwise modified, and/or other steps and/or communications may be added. A communication shown in, and/or described in connection with, FIGS. 4A-4D need not be a single message nor contained in a single packet, block, or other transmission unit.

FIGS. 4A-4B and steps 402-420a/b describe how a call may be established between the initiating device 310 and the far-end device 340 using the controller 320 to host the call session. The communication paths may be similar to what was shown and described with respect to FIG. 3A. Referring to FIG. 4A, at step 402, the initiating device 310 may send a SIP invite to the controller 320. For example, the SIP invite may include information indicating an end-point of the call (e.g., the far-end device 340) and an indication that the call is a priority call. For example, an individual corresponding to the initiating device 310 may dial 911 to be connected to an emergency operator. However, any kind of indication that the call may be a priority may be configured and used without departing from the scope of the disclosure. For example, any entity or organization may opt into a service that enables their calls to include a priority indication.

Additionally or alternatively, the initiating device 310 may receive a message from the controller 320, for example, after sending the SIP invite to the controller 320. The message may comprise a “100 trying” message. The message, (e.g., the “100 trying” message) may indicate to the initiating device 310 that the SIP invite the initiating device 310 sent was received by the controller 320.

At step 404, the controller 320 may determine that the call is a priority call, based on the indication in the SIP invite that the initiating device 310 sent to the controller 320 at step 402. For example, if the user corresponding to the initiating device 310 dials 911, then the controller 320, based on receiving an indication that the request is a 911 call, may determine that the call is a priority call. Although an emergency may be an example of a priority, other priorities (e.g., a government priority, a private entity priority, etc.) may similarly be contemplated.

At step 406, the controller 320 may send the SIP invite to the switch 330. For example, the SIP invite may be the same SIP invite that was sent by the initiating device 310 at step 402. Additionally or alternatively, the controller 320 may modify the SIP invite before sending it to the switch 330 without departing from the scope of the disclosure (by, e.g., noting that the controller 320 successfully received the SIP invite). The SIP invite may contain information that indicates to the switch 330 an end-point for the SIP invite, such as the far-end device 340, and/or information indicating that the call is a priority call. Additionally or alternatively, the controller 320 may receive a “100 trying” message from the switch 330 after sending the SIP invite to the switch 330, which may indicate to the controller 320 that the SIP invite was received by the switch 330.

At step 408, the switch 330 may store the priority call information. For example, the switch 330 may store the priority call information in furtherance of setting up an alternate path for the call in the event a call session corresponding to the call is transferred from the controller 320 to the alternate controller 350, as discussed in further detail below.

At step 410, the switch 330 may send the SIP invite to the far-end device 340. For example, the SIP invite may be the same SIP invite that was sent by the controller 320 at step 406. Additionally or alternatively, the switch 330 may modify the SIP invite before sending the SIP invite to the far-end device 340 without departing from the scope of the disclosure (by, e.g., noting that the switch 330 successfully received the SIP invite). For example, the switch 330 may receive a “100 trying” message from the far-end device 340 after sending the SIP invite to the far-end device 340, which may indicate to the switch 330 that the far-end device 340 received the SIP invite. Additionally or alternatively, for example, the switch 330 may also receive a “180 ringing” message from the far-end device 340, which may be forwarded to the controller 320, which the controller 320 may subsequently forward to the initiating device 310 without departing from the scope of the disclosure. For example, a “180 ringing” message may indicate that the SIP invite reached its destination/end-point (e.g., received by the far-end device 340).

Referring to FIG. 4B, at step 412, the far-end device 340 may send an indication accepting the SIP invite that originated from the initiating device 310, to the switch 330. For example, the indication may be a “200 OK” message. For example, a “200 OK” message may indicate that request to establish a call, as part of the SIP invite, was accepted by an end-point of the call (e.g., accepted by the far-end device 340).

At step 414, the switch 330 may send the accepted SIP invite to the controller 320. For example, the accepted SIP invite may be the same accepted SIP invite that was sent by the far-end device 340 at step 412. Additionally or alternatively, the switch 330 may modify the accepted SIP invite before sending the accepted SIP invite to the controller 320 without departing from the scope of the disclosure (by, e.g., noting that the switch 330 successfully received the SIP message).

At step 416, the controller 320 may synchronize with the alternate controller 350, for example, via an HA layer (e.g., HA layer 380 of FIGS. 3A and/or 3B). For example, the synchronization at step 416 may enable an alternate path to be pre-emptively set up so that the alternate controller 350 may be prepared to host a transferred call session between the initiating device 310 and the far-end device 340. For example, the synchronizing may include the controller 320 first sending a message to the alternate controller 350, for example, using the HA layer, requesting to synchronize with the alternate controller 350. The alternate controller 350 may, for example, based on receiving the message, send a response to the controller 320 indicating that the message was successfully received by the alternate controller 350. For example, in synchronizing, a communication link may be established between the controller 320 and the alternate controller 350 so that the controller 320 and the alternate controller 350 are configured to receive a request (from, e.g., the initiating device 310) to transfer a call session, as discussed in more detailed at step 428 (FIG. 4C).

At step 418, the controller 320 may send the accepted SIP invite to the initiating device 310. For example, the accepted SIP invite may be the same accepted SIP invite that was sent by the switch 330 at step 414. Additionally or alternatively, the switch 330 may modify the accepted SIP invite before sending the SIP invite to the controller 320 without departing from the scope of the disclosure (by, e.g., noting that the controller 320 successfully received the SIP message).

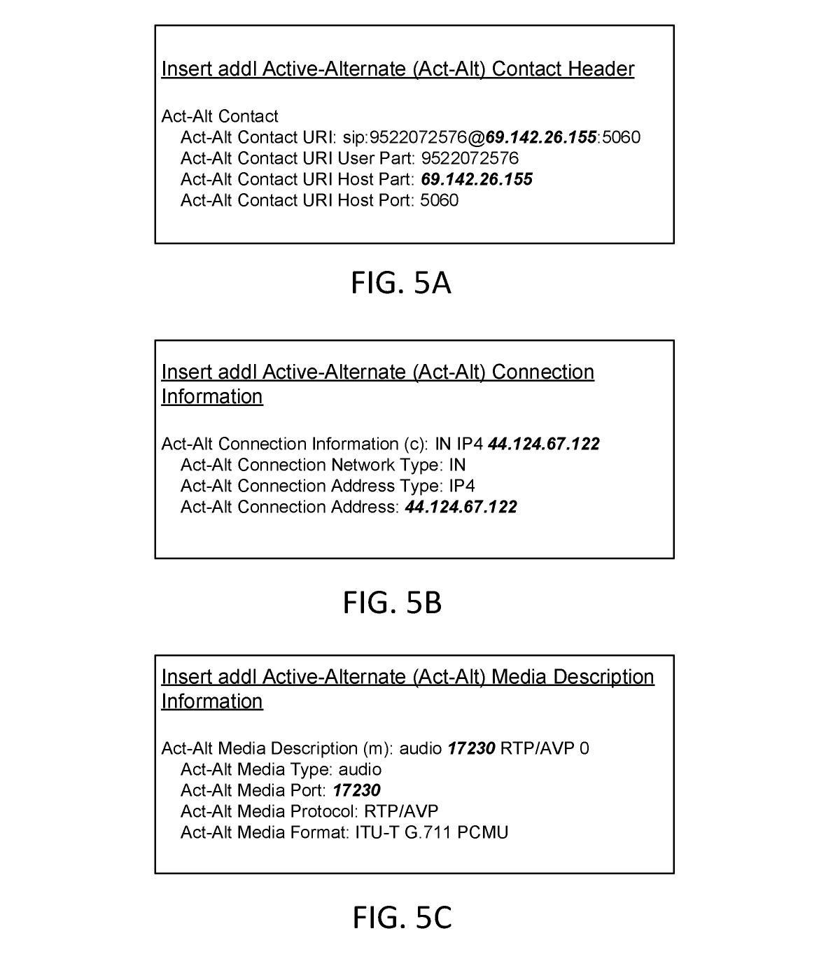

The controller 320 may additionally send information to the initiating device 310 indicating an alternate path for the call using the alternate controller 350 as the host of the call session, in the event that poor quality associated with the call is detected, or in the event that the call fails. The information may be similar to what is shown and described with reference to FIGS. 5A-5C. For example, the controller 320 may insert packet header information into the accepted SIP invite before sending the accepted SIP invite to the initiating device 310 as part of the actions performed at step 418. In this manner, the initiating device 310 may be informed of the alternate path based on the packet header information that the controller 320 inserted into the accepted SIP invite. Additionally or alternatively, the controller 320 may separately send the packet header information (e.g., in a separate SIP invite) to the initiating device 310 without departing from the scope of the disclosure.

At step 420a, the initiating device 310 may establish the call via the media layer 370, for example, after receiving the accepted SIP invite that was sent at step 418. The accepted SIP invite may also include information that identifies an alternate path for the call, for example, in the event that the call needs to be transferred to a different host (e.g., transferred from the controller 320 to the alternate controller 350).

At step 420b, the far-end device 340 may establish the call via the media layer 370. For example, steps 420a and 420b may be performed substantially simultaneously, and after both steps 420a and 420b have been performed, then the initiating device 310 and the far-end device 340 may communicate with each other using the media layer 370 (e.g., performance of steps 420a and 420b may cause the call to be established between the initiating device 310 and the far-end device 340).

FIGS. 4C-4D describe how the call may be automatically transferred to an alternate path using the alternate controller 350 to host the transferred call session. The communication paths may be similar to what was shown and described with respect to FIG. 3B. Referring to FIG. 4C, at step 422, the initiating device 310 may determine poor quality exists for the previously established call with the far-end device 340 and hosted by the controller 320 (representing, e.g., occurrence of a call condition). Although step 422 refers to the case in which the call condition is associated with poor quality, a call failure may similarly be determined and similar actions may be subsequently performed (e.g., steps 424-442a/b). For example, poor quality may be determined based on the initiating device 310 determining packet loss information associated with the call. Also or alternatively, the poor quality determination may be based on a determination that packet losses are greater than a threshold. Also or alternatively, the determination may be based on a quantity of packet losses greater than a threshold within a period of time. Other types of quality information may be used, such as jitter, latency, bandwidth, or the like, and if the quality information falls below a quality threshold, the call may be transferred. For example, the initiating device 310 may receive a real-time transport control protocol (RTCP) report from the controller 320, which may comprise quality information associated with the call. Although step 422 describes that the initiating device 310 may determine poor quality associated with the call, other devices (e.g., the controller 320) may similarly determine poor quality associated with the call without departing from the scope of the disclosure.

At step 424, the initiating device 310 may trigger a switchover (e.g., failover) based on, for example, the quality determination made at step 422. A switchover may refer to a process in which a call session may be transferred from a controller (e.g., controller 320) that was the host of a call session to an alternate controller (e.g., alternate controller 350) as the new host of the call session and using an alternate path for the call. The switchover may occur while the call between the initiating device 310 and the far-end device 340 is maintained and without disconnecting the call. Although step 424 describes that the initiating device 310 may automatically trigger the switchover, other devices (e.g., the controller 320) may similarly trigger the switchover.

At step 426, the initiating device 310 may send a new SIP invite to both the controller 320 and the alternate controller 350 to initiate the process of transferring the call session host (and the call session) from the controller 320 to the alternate controller 350. For example, the initiating device 310 may use the information that was previously sent by the controller 320 at step 418 (e.g., information similar to what is shown by FIGS. 5A-5C), which indicated the alternate path for the transferred call using the alternate controller 350 as the host of the transferred call session.

At step 428, the controller 320 may transfer the call session to the alternate controller 350 by sending a message to the alternate controller 350 indicating that a switchover was triggered. For example, the controller 320 may send the message and cause the call session to be transferred to the alternate controller 350 based on the previous synchronization performed at step 416 (FIG. 4B) and using the HA layer 380.

At step 430, the controller 320 may send a new SIP invite to the switch 330. The new SIP invite may be configured to coordinate the switchover from the controller 320 to the alternate controller 350 to transfer the call session. Additionally or alternatively, the new SIP invite may be the same new SIP invite that was sent by the initiating device 310 at step 426. Additionally or alternatively, the controller 320 may modify the SIP invite before sending the SIP invite to the switch 330 without departing from the scope of the disclosure (by, e.g., noting that the controller 320 successfully received the new SIP invite).

At step 432, the alternate controller 350 may send a new SIP invite to the switch 330. For example, the new SIP invite may be the same new SIP invite that was sent by the initiating device 310 at step 426. Additionally or alternatively, the alternate controller 350 may modify the SIP invite before sending the SIP invite to the switch 330 (by, e.g., noting that the alternate controller 350 successfully received the SIP message). Although described sequentially, steps 430 and 432 may be performed in parallel or step 432 may be performed before step 430 without departing from the scope of the disclosure.

Referring to FIG. 4D, at step 434, the switch 330 may send the new SIP invite to the far-end device 340. For example, the switch 330 may send the new SIP invite to the far-end device 340 after receiving the new SIP invite from both the controller 320 and the alternate controller 350.

At step 436, the far-end device 340 may send an indication accepting the new SIP invite to the switch 330. For example, the indication may be a “200 OK” message. For example, the “200 OK” message may indicate that the far-end device 340 received and accepted the new SIP invite to transfer the call session from the controller 320 to the alternate controller 350.

At step 438, the switch 330 may send the accepted new SIP invite to the alternate controller 350. For example, the accepted new SIP invite may be the same accepted new SIP invite that was sent by the far-end device 340 at step 436. Additionally or alternatively, the switch 330 may modify the accepted new SIP invite before sending the accepted new SIP invite to the alternate controller 350 without departing from the scope of the disclosure (by, e.g., noting that the switch 330 successfully received the accepted new SIP invite). Additionally or alternatively, the switch 330 may also send the accepted new SIP invite to the controller 320 (not shown) without departing from the scope of the disclosure.

At step 440, the alternate controller 350 may send the accepted new SIP invite to the initiating device 310. For example, the accepted new SIP invite may be the same accepted new SIP invite that was sent by the switch 330 at step 438. Additionally or alternatively, the alternate controller 350 may modify the accepted new SIP invite before sending the accepted new SIP invite to the initiating device 310 without departing from the scope of the disclosure (by, e.g., noting that the alternate controller 350 successfully received the new SIP invite).

At step 442a, the initiating device 310 may establish the call with the far-end device 340 using the alternate path and with the alternate controller 350 as the host of the transferred call session (via media layer 370).

At step 442b, the far-end device 340 may similarly establish the call with the initiating device 310 using the alternate path and via the alternate controller 350. The far-end device 340 may establish the call with the initiating device 310 using the alternate path and via the alternate controller 350 without the call being disconnected, which may be advantageous, for example, if the call is associated with a priority (e.g., emergency) event. Also or alternatively, steps 442a and 442b may be performed substantially simultaneously, and after both steps 442a and 442b have been performed, the initiating device 310 and the far-end device 340 may communicate with each other using the media layer 370 and with the alternate controller 350 as the host of the call session (e.g., performance of steps 442a and 442b may cause the call to be established between the initiating device 310 and the far-end device 340).

Although described with reference to transferring a call session from the controller 320 to the alternate controller 350, similar actions may be performed in order to transfer a call session to a different alternate controller, transfer a call session back to the controller 320, or the like. Further, two active calls may be established for the initiating device 310 and the far-end device 340 using the controller 320 and the alternate controller 350 without departing from the scope of the disclosure. Additional advantageous related to the actions performed with respect to FIGS. 4A-4D comprise increase accuracy with respect to resiliency testing. For example, during resiliency testing, priority (e.g., emergency) calls, which may have previously been manually transferred to a different data center (e.g., a different controller) during the resiliency testing, might not need to be manually transferred due to the ability to automatically switchover from one controller to an alternate controller, as previously described with reference to FIGS. 4A-4D.

FIGS. 5A-5C show examples of information that may be used to establish, maintain, and/or otherwise transfer a call using an active-alternate path. For example, any of the information described by FIGS. 5A-5C may be included within the information that was sent to the initiating device 310 at step 418, and/or used by the initiating device 310 as part of the actions performed at step 426. For example, the controller 320 may insert information into a packet (e.g., a SIP message) that indicates the alternate path, based on the call indicating a priority message. FIG. 5A shows example information (e.g., contact header information) that may be included in a SIP message, for example, in order to identify an alternate path for a call. For example, the information may include a SIP ID, which may include an identification of the contact information for the user part, the host part, and the host part of the alternate controller 350. FIG. 5B shows an example of media connection information associated with the alternate path. For example, the information may include a connection network type, a connection address type, and a connection address associated with the alternate controller 350. FIG. 5C shows an example of media description information associated with the alternate path. For example, the media description information may include information such as a media type, a media port, a media protocol, and/or a media format associated with the alternate controller 350. Although FIGS. 5A-5C were described as separate examples of information that may be included in a SIP message, a SIP message may include any of the information described with reference to FIGS. 5A-5C without departing from the scope of the disclosure.

FIG. 6 is a flow chart showing an example method for establishing a call and maintaining a call using an active-alternate path. One, some, or all of the steps of the example method of FIG. 6 may be performed by a computing device, for example, the controller 320. At step 601, the computing device (e.g., the controller 320) may receive a request from an initiating device (e.g., the initiating device 310). The request may indicate that the initiating device would like to establish a call with a far-end device (e.g., the far-end device 340). The request may also indicate that the call is associated with a priority call.

At step 602, the computing device may determine that the request from the initiating device comprises a priority indication. Based on determining that the request comprises a priority indication, the computing device may proceed to step 603 and synchronize with a second computing device (e.g., the alternate controller 350). For example, the computing device and the second computing device may be configured to host one or more call sessions between initiating devices.

At step 603, the computing device may synchronize with the second computing device to pre-emptively set up an alternate path for the call in the event the call session needs to be transferred from the computing device as the host to the second computing device as the new host. For example, the synchronizing may be similar to the synchronizing that was described with respect to step 416 (FIG. 4B).

At step 604, the computing device may send an invite (e.g., a SIP invite, for example, as described with reference to FIGS. 5A-5C), for example, corresponding to the request that the computing device received at step 601, to a switch (e.g., switch 330). For example, the sending may be similar to the actions performed at step 406 (FIG. 4A).

At step 605, the computing device may receive an acceptance from the switch (e.g., based on the far-end device accepting the invite). For example, the receiving the acceptance may comprise the actions performed at step 414 (FIG. 4B).

At step 606, the computing device may send the acceptance to the initiating device. For example, the sending the acceptance may comprise the actions performed at step 418 of FIG. 4C (e.g., sending the accepted SIP invite, inserting packet header information into the accepted SIP invite indicating the alternate path before sending the accepted SIP invite, etc).

At step 607, the computing device may host the established call between the initiating device and the far-end device.

At step 608, the computing device may determine whether to transfer the call. For example, the determination of whether to transfer the call may be based on a received request to transfer the call (e.g., received from the initiating device, similar to the actions performed at step 424 of FIG. 4C). Also or alternatively, the computing device may make the determination to transfer the call without departing from the scope of the disclosure. The received request may be based on poor quality (e.g., poor call quality related to packet loss). For example, the determination could be based on the initiating device triggering a switchover (e.g., failover) and sending a new invite (e.g., a new SIP invite) to the computing device. If the computing device does not determine to transfer the call, then the computing device may proceed back to step 608 and continue hosting the call.

At step 609, the computing device may transfer the call session to the second computing device (e.g., the alternate controller 350). The transferring may comprise the actions performed at step 428 (FIG. 4C).

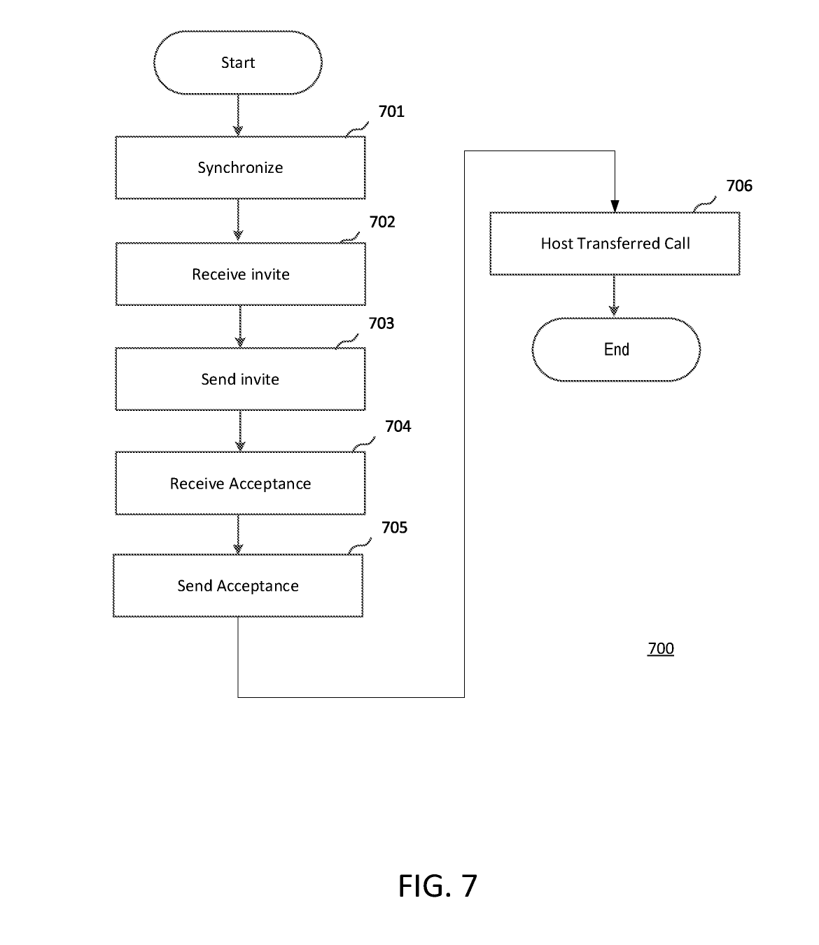

FIG. 7 is a flow chart showing an example method for establishing a call and maintaining the call using an active-alternate path. One, some, or all of the steps of FIG. 7 may be performed by a computing device (e.g., the alternate controller 350). At step 701, the computing device may synchronize with a second computing device (e.g., the controller 320), so that the computing device may be ready (e.g., pre-emptively ready) to host a transferred call session, for example, between a initiating device (e.g., initiating device 310) and a far-end device (e.g., far-end device 340) that was previously hosted by the second computing device. The synchronizing may comprise the actions performed at step 416 (FIG. 4B).

At step 702, the computing device may receive an invite (e.g., the new SIP invite sent by the initiating device 310 at step 426 of FIG. 4C, which was sent in response to triggering the switchover at step 424) that indicates the second computing device is transferring the call session to the computing device.

At step 703, the computing device may send the invite to a switch (e.g., switch 330), which may ultimately be sent to a far-end device (e.g., far-end device 340 by the switch 330). At step 704, the computing device may receive a message indicating an acceptance of the invite from the switch. The acceptance may have originated from the far-end device, for example, and sent to the switch. For example, the receiving may comprise the actions performed at step 438 (FIG. 4D).

At step 705, the computing device may send the acceptance to the initiating device. For example, the sending may comprise the actions performed at step 440 (FIG. 4D). At step 706, the computing device may host the transferred call session using an alternate path that was established between the initiating device and the far-end device. For example, the alternate path may refer to a path between the initiating device and the far-end device in which the computing device hosts the call session, as opposed to the original path in which the second computing device hosts the call session.

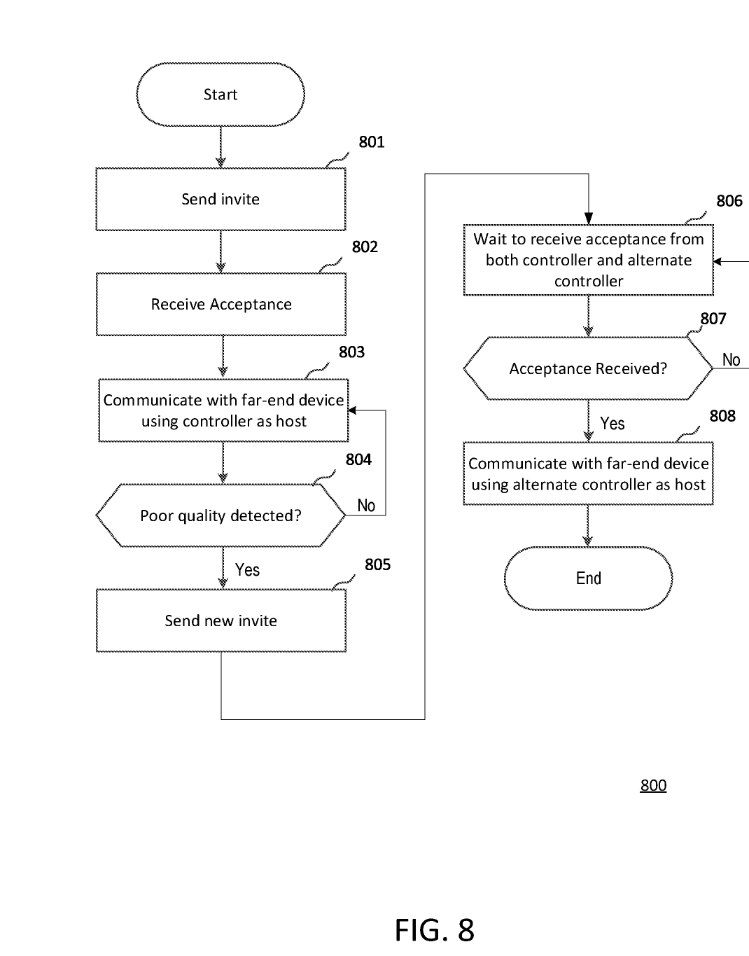

FIG. 8 is a flow chart showing an example method for establishing a call and maintaining the call using an active-alternate path. One, some, or all of the steps of FIG. 8 may be performed by a computing device (e.g., initiating device 310). At step 801, the computing device may send an invite (e.g., a SIP invite) to a second computing device (e.g., controller 320).

At step 802, the computing device may receive a message indicating an acceptance of the invite from a far-end device (e.g., the far-end device 340, and via the switch 330 and/or the controller 320). For example, in receiving the message, the computing device may also receive packet header information indicating an alternate path for the call, in the event that poor quality associated with the call is detected, or in the event that the call fails. The packet header information may have previously been inserted into the message indicating the acceptance (e.g., inserted into a SIP message), by the second computing device (e.g., the controller 320), the far-end device (e.g., the far-end device 340), or the switch (e.g., the switch 330) without departing from the scope of the disclosure.

At step 803, the computing device may communicate, for example, in a call session, with the far-end device via a media layer (e.g., media layer 370) and using a controller (e.g., the controller 320) as the host of the call session.

At step 804, the computing device may determine whether poor quality associated with the call has been detected. If poor quality is not detected, then the computing device may proceed back to step 803 and continue communicating with the second computing device. If poor quality is detected, then the computing device may proceed to step 805.

At step 805, the computing device may send a new invite to the controller (e.g., the controller 320) and an alternate controller (e.g., the alternate controller 350) to transfer the call to the alternate path using the alternate controller as the host of the transferred call session.

At step 806, the computing device may wait to receive a message indicating an acceptance of the new invite from both the controller and the alternate controller. At step 807, the computing device may determine whether the computing device has received a message indicating an acceptance of the invite from both the controller and the alternate controller. If the computing device has determined that a message indicating the acceptance has not been received, then the computing device may proceed back to step 807 and wait to receive the message indicating the acceptance from the controller and the alternate controller. If the computing device has determined that the message indicating the acceptance has been received, then the computing device may proceed to step 808.

At step 808, the computing device may communicate with the far-end device via the media layer 370 and using the alternate controller (e.g., the alternate controller 350) as the host of the transferred call session.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a controller, a request to initiate a call between an initiating device and a receiving device;
identifying, based on the request, an indication that the call is a priority call;
determining, based on the indication that the call is the priority call, an alternate path for the call;
inserting packet header information into a message that indicates the alternate path for the call;
causing the call to be established between the initiating device and the receiving device via the controller; and
based on occurrence of a call condition, and based on the packet header information that indicates the alternate path, causing a session corresponding to the call to be transferred to an alternate controller.

2. The method of claim 1, wherein the occurrence of the call condition comprises occurrence of a call failure.

3. The method of claim 1, wherein the occurrence of the call condition comprises determining that the call has low quality, and wherein determining that the call has low quality is based on a quantity of lost packets associated with the call exceeding a threshold.

4. The method of claim 1, further comprising:
receiving, by the controller, a session initiation protocol (SIP) message indicating that the call is a priority, and wherein the session is further transferred based on the indication.

5. The method of claim 1, further comprising:
preconfiguring the controller with information that identifies the alternate controller.

6. The method of claim 1, wherein the indication that the call is a priority call is within a session initiation protocol (SIP) message received from the initiating device.

7. The method of claim 1, further comprising:
synchronizing with the alternate controller based on the indication, wherein the synchronizing comprises:
sending, using the controller and via a high-availability interface, a message to the alternate controller indicating a request to synchronize with the alternate controller; and
receiving, from the alternate controller, a response indicating the message was successfully received.

8. The method of claim 1, further comprising:
sending, using the controller, the message to the initiating device that includes the packet header information indicating the alternate path.

9. The method of claim 8, wherein the message to the initiating device that indicates the packet header information related to establishing an alternate session comprises one or more of:
contact header information, connection information, or media description information.

10. The method of claim 1, wherein the alternate controller is located at a data center outside of a geographic region associated with the controller.

11. A method comprising:
receiving, at a computing device, a request to establish a communication session and an indication that the communication session is associated with a priority event;
determining, based on the indication that the communication session is associated with the priority event, an alternate path for the communications session;
inserting packet header information into a message that indicates the alternate path for the communication session;
causing a connection between a local device and a receiving device to be established to create the communication session using the computing device;
determining that the communication session falls below a quality threshold; and
based on the determining, and based on the packet header information that indicates the alternate path, causing a transfer from the computing device to an alternate computing device.

12. The method of claim 11, further comprising:
sending, to a switch, a request to cause the connection between the local device and the receiving device to be established to create the communication session.

13. The method off claim 11, wherein the determining that the communication session is low quality is based on a quantity of lost packets associated with the call exceeding a threshold.

14. The method of claim 11, further comprising:
receiving, by the computing device, a session initiation protocol (SIP) message indicating that the communication session is a priority, and wherein the causing is further based on the priority.

15. The method of claim 11, further comprising:
preconfiguring the computing device with information that identifies the alternate computing device.

16. The method of claim 11, further comprising:
sending a SIP message to the local device that indicates information related to establishing an alternate communication session hosted by the alternate computing device, based on the indication that the communication session is associated with a priority event, wherein the information is inserted into the SIP message by the computing device.

17. A method comprising:
sending, by an initiating device, a request to initiate a call and an indication that the call is a priority;
receiving, by the initiating device, packet header information indicating an alternate path associated with the call;
communicating with a receiving device; and
based on determining that quality of the call is poor, and based on the packet header information, sending a new request to transfer the call using the alternate path.

18. The method of claim 17, wherein the request to initiate the call comprises a session initiation protocol (SIP) message.

19. The method of claim 17, wherein a controller is used to host a call session associated with the call to communicate with the receiving device, and wherein the method further comprises:
sending, using the initiating device, the new request to transfer the call to the controller.

20. The method of claim 17, wherein the packet header information about the alternate path comprises an indication of an alternate controller to host the transferred call, and wherein the method further comprises:
sending, using the initiating device, the new request to transfer the call to the alternate controller, based on the packet header information about the alternate path.
